(19) United States
(12) Patent Application Publication
(10) Pub. No.: US 2024/0141089 A1
(43) Pub. Date: May 2, 2024

(54) Process for manufacturing cross-linkable biopolymers

(71) Applicant: Cellcraft Ltd., London (GB)

(72) Inventor: Jopeth M. Ramis, Rizal (PH)

(73) Assignee: Cellcraft Ltd., London (GB)

(21) Appl. No.: 18/548,646

(22) PCT Filed: Mar. 1, 2022
(86) PCT No.: PCT/IB2022/051794

§ 371 Date: Sep. 1, 2023

(30) Foreign Application Priority Data
Mar. 2, 2021 (PH) 12021050085

(51) Int. Cl. C08F 251/00; C08F 222/04; C08F 238/00; C08F 289/00; C08J 3/05; C08J 3/09; C08J 3/24; C08L 5/04; C08L 5/08; C08L 89/06

(52) U.S. Cl. CPC C08F 251/00; C08F 222/04; C08F 238/00; C08F 289/00; C08J 3/05; C08J 3/091; C08J 3/24; C08L 5/04; C08L 5/08; C08L 89/06; C08J 2305/04; C08J 2305/08; C08J 2351/02; C08J 2389/06; C08L 2203/02

(57) ABSTRACT

The present invention relates to a process for manufacturing a biopolymer chemically modified with a functional group selected from a carbon-carbon double bond, a carbon-carbon triple bond and a nitrogen-nitrogen triple bond, wherein following chemical modification in an aqueous solution, the biopolymer is precipitated in an organic solvent, filtered and dried, and the organic solvent is recovered by distillation. A biopolymer chemically modified with a functional group selected from a carbon-carbon double bond, a carbon-carbon triple bond and a nitrogen-nitrogen triple bond obtained by said manufacturing process, and a hydrogel thereof are also provided.

### FIELD OF THE INVENTION

The present application relates to the technical field of cross-linkable biopolymers and processes for industrial scale production of cross-linkable biopolymers, such as cross-linkable proteins and cross-linkable polysaccharides.

### BACKGROUND OF THE INVENTION

The search for a base biomaterial in tissue engineering and regenerative medicine applications requires that said base biomaterial has the following intrinsic properties: biocompatibility, degradability by enzymes naturally secreted by cells in culture, tunable physical and chemical properties, and of course, economical and reproducible production processes. Modified cross-linkable biopolymers (i.e. biopolymers that have been modified with functional groups that render the biopolymers cross-linkable) present these intrinsic properties and have been extensively used by numerous investigators for culturing vast array of cells. Following chemical modification with a chemical modifying agent to render them cross-linkable, the following biopolymers have been commonly used as the base biomaterial for bioprinting applications, being the base ink laden with cells: gelatin, alginate, hyaluronic acid, chitosan, chondroitin sulphate, collagen, and silk fibroin.

The currently used processes for manufacturing cross-linkable biopolymers rely upon the use of dialysis as purification method of the cross-linkable biopolymers. Specifically, upon completion of the reaction, the reaction products of the biopolymers chemical modification are poured onto a membrane and suspended in water for several days at a constant temperature. The unwanted reaction products, such as the unreacted chemical modifying agent, by-products thereof, and the buffer salts diffuse out of the membrane upon suspension with water while the cross-linkable biopolymer is retained in the membrane. Daily constant replacement of water purifies the cross-linkable biopolymer inside the membrane, with only the cross-linkable biopolymer dissolved in water remaining. The water will be eventually removed by freeze drying the solution, leaving a foamy structure after processing as shown in FIG. 2a. Dialysis usually lasts for seven days, and freeze drying for four to seven days (Nichol et al., Biomaterials 31 (2010) 5536-5544) depending on the water content of the post dialysis cross-linkable biopolymer. Hence, the currently available processes for manufacturing cross-linkable biopolymers involve a total purification time of about eleven to fourteen days. During these manufacturing processes, large volume with low content of cross-linkable biopolymers are processed, making the purification limited to a few grams of dried cross-linkable biopolymer. The resulting cross-linkable biopolymer is under foam form, thereby requiring large storage spaces.

As the currently used processes for manufacturing cross-linkable biopolymers relying upon the use of dialysis as purification method are lengthy (multi-day processing time limits), provide only limited amounts of cross-linkable biopolymers in a foam form and suffer from reproducibility, there is an unmet need to provide an expedient, reproducible and environmentally friendly process for manufacturing a cross-linkable biopolymer, preferably as a particulate, which can be easily stored and handled.

### SUMMARY OF THE INVENTION

Accordingly, it is an object of the present invention to provide an expedient, scalable and environmentally friendly process for manufacturing a biopolymer chemically modified with a functional group selected from a carbon-carbon double bond, a carbon-carbon triple bond and a nitrogen-nitrogen triple bond. The object is achieved by the process for manufacturing according to claim 1.

Also claimed and described herein is a biopolymer chemically modified with a functional group selected from a carbon-carbon double bond, a carbon-carbon triple bond and a nitrogen-nitrogen triple bond, preferably in a particulate form, obtained by the manufacturing process claimed and described herein. The particulate claimed and described herein can be stored in significantly smaller spaces as compared to the known cross-linkable biopolymer purified via dialysis. Further, the biopolymer chemically modified obtained by the process claimed and described herein exhibits better mechanical strength properties than the known cross-linkable biopolymer purified via dialysis.

A further aspect according to the present invention is directed to a hydrogel obtained from the biopolymer chemically modified with a functional group selected from a carbon-carbon double bond, a carbon-carbon triple bond and a nitrogen-nitrogen triple bond claimed and described herein.

### SHORT DESCRIPTION OF THE FIGURES

FIG. 1. Process flow diagram of an industrial manufacturing process according to the present invention.

FIG. 2. Photomicrograph (left) and scanning electron micrographs (center and right) of dialyzed (top row) and (bottom row) precipitated gelatin methacrylate.

FIG. 3. Representative thermogravimetric curves of (left) dialyzed and (right) precipitated gelatin methacrylate. X-axis, % weight, Y-axis, temperature (° C.).

FIG. 4. Chromatogram (left column) and molecular weight distribution (right column) of dialyzed (top row) and precipitated (bottom row) gelatin methacrylate using gel permeation chromatography. X-Axis of chromatogram, left column, elution time. Left column: y axis left, mV, y-axis right, log MW. Studentized t-test shows significant difference between number averaged molecular weight (Mn) and weighted averaged molecular weight (Mw) (***p<0.0001, n=3); y-axis, molecular weight. Calculated polydispersity for dialyzed (first and second bars) and precipitated gelatin methacrylate (third and fourth bar) was 1.85±0.024 and 2.35±0.016 respectively. Error bars represent standard deviation (SD).

FIG. 5. (Top) gelatin methacrylate hydrogels from left to right: 5% dialyzed gelatin methacrylate, 5% precipitated gelatin methacrylate, 10% dialyzed gelatin methacrylate and 10% precipitated gelatin methacrylate.

(bottom left) Compressive modulus with y-axis (young's modulus, kPa), x-axis first bar from the left, 5% dialyzed gelatin methacrylate, second bar, 5% precipitated gelatin methacrylate, third bar, 10% dialyzed gelatin methacrylate and fourth bar, 10% precipitated gelatin methacrylate; and
(bottom right) swelling ratio of gelatin methacrylate hydrogels y-axis (swelling ratio), x-axis first bar, 5% dialyzed gelatin methacrylate, second bar, 5% precipitated gelatin methacrylate, third bar, 10% dialyzed gelatin methacrylate and fourth bar, 10% precipitated gelatin methacrylate; error bars as standard deviations. Different concentration and downstream processing techniques show statistically significant differences via ANOVA and Tukey's post hoc test (*p<0.05, **p<0.01, ***p<0.001, n≥3).
Error bars represent standard deviation (SD).

FIG. 6. Strain sweep of (top left) 5% dialyzed, (top right) 5% precipitated, (bottom left) 10% dialyzed, and (bottom right) 10% precipitated gelatin methacrylate at 1 Hz and a temperature of 37° C. Square points are the storage modulus, triangles are the loss modulus. X-axis, strain (%) and y-axis, G′ and G″ in Pa.

FIG. 7. Frequency sweep of (top left) 5% dialyzed, (top right) 5% precipitated, (middle left) 10% dialyzed, and (middle right) 10% precipitated gelatin methacrylate at 0.5% strain and a temperature of 37° C. Square points are the storage modulus, triangles are the loss modulus. X-axis, strain (%) and y-axis, G′ and G″ in Pa. Bar graphs of the determined storage (bottom left) and loss (bottom right) moduli on all samples with y-axis on (bottom left) storage modulus and y-axis on (bottom right) loss modulus, x-axis first bar from the left, 5% dialyzed gelatin methacrylate, second bar, 5% precipitated gelatin methacrylate, third bar, 10% dialyzed gelatin methacrylate and fourth bar, 10% precipitated gelatin methacrylate. Statistically significant differences between 5% dialyzed gelatin methacrylate and precipitated gelatin methacrylate to 10% precipitated gelatin methacrylate at 95% CI via ANOVA and Tukey's post hoc test (*p <0.05, **p <0.01, n≥3). Error bars represent standard deviation (SD).

FIG. 8. Time sweep of (top left) 5% dialyzed gelatin methacrylate, (top right) 5% precipitated gelatin methacrylate, (bottom left) 10% dialyzed gelatin methacrylate, and (bottom right) 10% precipitated gelatin methacrylate at 1 Hz, 0.5% Strain and a temperature of 37 ° C. Square points are the storage modulus, triangles are the loss 40 modulus. X-axis, time (s) and y-axis, G′ and G″ in Pa.

FIG. 9. Temperature sweep of (top left) 5% dialyzed gelatin methacrylate, (top right) 5% precipitated gelatin methacrylate, (bottom left) 10% dialyzed gelatin methacrylate, and (bottom right) 10% precipitated gelatin methacrylate at 1 Hz, 0.5% Strain, and heating rate of 2° C./min. Square points are the storage modulus, triangles are the loss modulus. X-axis, temperature (° C.) and y-axis, G′ and G″ in Pa.

FIG. 10. (top) Cell viability assessment of NIH 3T3 fibroblasts encapsulated in 5% dialyzed and precipitated (first and second row), and 10% dialyzed and precipitated (third and fourth row) gelatin methacrylate at day 1 (left side) and day 4 (right side), using Live (green, Calcien-AM)-Dead (red, Ethidium homodimer) stain. (bottom) Bar graph showing no significant difference on cellular viabilities between culture days (Repeated measures ANOVA, p=0.1114, at least 50 cells in each 3 different regions were analysed). Error bars represent standard deviation (SD). X-axis: left grouped bars—day 1, from left to right: first bar, 5% dialyzed gelatin methacrylate, second bar, 5% precipitated gelatin methacrylate, third bar, 10% dialyzed gelatin methacrylate and fourth bar, 10% precipitated gelatin methacrylate; right grouped bars—day 4, from left to right: first bar, 5% dialyzed, second bar, 5% precipitated, third bar, 10% dialyzed and fourth bar, 10% precipitated gelatin methacrylate. Y axis: cell viability in %.

### DETAILED DESCRIPTION OF THE INVENTION

Thus, it is an object of the present invention to address this need. The objective is achieved by a process of manufacturing as defined in claim 1, a biopolymer chemically modified with a functional group selected from a carbon-carbon double bond, a carbon-carbon triple bond and a nitrogen-nitrogen triple bond as defined in claim 14 and a hydrogel as defined in claim 15. Preferred embodiments are disclosed in the specification and the dependent claims.

The present invention will be described in more detail below.

Where the present description refers to “preferred” embodiments/features, combinations of these “preferred” embodiments/features are also deemed to be disclosed as long as the specific combination of the “preferred” embodiments/features is technically meaningful.

Unless otherwise stated, the following definitions shall apply in this specification:

As used herein, the term “a”, “an”, “the” and similar terms used in the context of the present invention (especially in the context of the claims) are to be construed to cover both the singular and plural unless otherwise indicated herein or clearly contradicted by the context.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”.

As used herein, the terms “including”, “containing” and “comprising” are used herein in their open-ended, non-limiting sense. It is understood that the various embodiments, preferences and ranges may be combined at will. Thus, for instance a solution comprising a compound A may include other compounds besides A. However, the term “comprising” also covers, as a particular embodiment thereof, the more restrictive meanings of “consisting essentially of” and “consisting of, so that for instance “a solution comprising A, B and optionally C” may also (essentially) consist of A and B, or (essentially) consist of A, B and C. As used herein, the transitional phrase “consisting essentially of” (and grammatical variants) is to be interpreted as encompassing the recited materials or steps “and those that do not materially affect the basic and novel characteristic(s) of the claimed invention. Thus, the term “consisting essentially of” should not be interpreted as equivalent of “comprising”.

As used herein, the term “about” means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Preferably, the range denoted by the term “about” denotes a range within ±3% of the value, more preferably ±1%. Generally, when the term “about” is used, it can be expected that similar results or effects according to the invention can be obtained with in a range of ±5% of the indicated value.

Surprisingly, it has been found that a process comprising the following steps:
(a) dissolving a biopolymer in an aqueous solution, wherein said biopolymer is selected from a protein, a polysaccharide, a salt thereof, and a mixture thereof;
(b) reacting the biopolymer with a chemical modifying agent containing a carbon-carbon double bond, a carbon-carbon triple bond, and/or a nitrogen-nitrogen triple bond to obtain a solution containing a biopolymer chemically modified with a functional group selected from a carbon-carbon double bond, a carbon-carbon triple bond and a nitrogen-nitrogen triple bond;
(c) adding the solution obtained at step (c) to an organic solvent to obtain a suspension containing a precipitate of the biopolymer chemically modified with the functional group selected from a carbon-carbon double bond, a carbon-carbon triple bond and a nitrogen-nitrogen triple bond;
(d) subjecting the suspension obtained at step (c) to filtration to obtain the precipitate and a filtrate;
(e) subjecting the filtrate to distillation to recover the organic solvent; and
(f) drying the precipitate to obtain the biopolymer chemically modified with the functional group selected from a carbon-carbon double bond, a carbon-carbon triple bond and a nitrogen-nitrogen triple bond, provides a biopolymer chemically modified with a functional group selected from a carbon-carbon double bond, a carbon-carbon triple bond and a nitrogen-nitrogen triple bond exhibiting improved mechanical strength properties as compared to the known cross-linkable biopolymers purified via dialysis, significantly reduces the processing time by decreasing the time required for purification and drying of the chemically modified biopolymer, is scalable and environmentally friendly. The manufacturing process claimed and described herein uses precipitation in an organic solvent as purification method of the biopolymer chemically modified instead of dialysis, thereby decreasing dramatically the time required for purification and drying of the chemically modified biopolymer.
As used herein, the term “biopolymer” refers to a protein, a polysaccharide, a protein salt, a polysaccharide salt, or a mixture thereof. The biopolymer described herein contains at least one free amine group and/or hydroxyl group and/or carboxylic acid group present on a majority of its monomeric units (amino acids, monosaccharides). The biopolymer described herein may be produced by a living organism or may be a derivative thereof. Thus, the biopolymer may be the same as a polymer found in the nature (i.e. a native biopolymer produced by a living or previously living organism, such as gelatin) or may be a derivative thereof (i.e. derived from a native biopolymer produced by a living or previously living organism, the derivatization being caused by the synthetic method used to isolate the biopolymer from nature).
The terms “chemical modifying agent containing a carbon-carbon double bond, a carbon-carbon triple bond, and/or a nitrogen-nitrogen triple bond”, “chemical modifying agent” and “chemical modifier” are used interchangeably in the present patent application and refer to a molecule or compound comprising one moiety that may react with an amine group and/or hydroxyl group and/or a carboxylic acid group of the biopolymer and a second moiety containing a carbon-carbon double bond (—C═C—), a carbon-carbon triple bond (—C≡C—), and/or a nitrogen-nitrogen triple bond (—N≡N—). “Moiety” as used herein, refers to a portion of a molecule or compound having a particular functional or structural feature. For example, a moiety may comprise a functional group or a reactive portion of a compound.
As used herein the term “biopolymer chemically modified with a functional group selected from a carbon-carbon double bond, a carbon-carbon triple bond and a nitrogen-nitrogen triple bond” refers to a biopolymer as described herein that has been reacted with a chemical modifying agent as described herein such that a part of the free amine groups and/or the hydroxyl groups and/or the carboxylic acid groups present on the biopolymer have been substituted with a moiety containing a carbon-carbon double bond, a carbon-carbon triple bond and/or a nitrogen-nitrogen triple bond. The expressions “chemically modified biopolymer” and “biopolymer chemically modified with a functional group selected from a carbon-carbon double bond, a carbon-carbon triple bond and a nitrogen-nitrogen triple bond” are used interchangeably in the present patent application. The introduction of the carbon-carbon double bond, the carbon-carbon triple bond and/or the nitrogen-nitrogen triple bond on the biopolymer is particular useful for the cross-linking of said biopolymer via methods well known in the art, such as thiol-ene reactions, thiol-yne reactions, and cycloadditions including strain-promoted azide-alkyne cycloaddition, and Diels-Alder cycloaddition. As used herein, the term cross-linking refers to the linking via a covalent bond of different portions of the biopolymer chemically modified with a functional group selected from a carbon-carbon double bond, a carbon-carbon triple bond and a nitrogen-nitrogen triple bond, or of different biopolymers, wherein at least one of said biopolymers is a biopolymer chemically modified with a functional group selected from a carbon-carbon double bond, a carbon-carbon triple bond and a nitrogen-nitrogen triple bond as described herein. The cross-linking involves the reaction of the carbon-carbon double bond, the carbon-carbon triple bond and/or the nitrogen-nitrogen triple bond present on the biopolymer chemically modified with a functional group selected from a carbon-carbon double bond, a carbon-carbon triple bond and a nitrogen-nitrogen triple bond, with a suitable functional group, such as a thiol group, an azido group and (a) double bond(s).

A preferred embodiment according to the present invention is directed to a process as claimed and described herein, further comprising step (g) conducted after step (f):
(g) subjecting the biopolymer obtained at step (f) to a size reduction method to provide a particulate of said biopolymer. The particulate provided by the manufacturing process claimed and described herein can be stored in significantly smaller spaces and can be handled more easily than the known cross-linkable biopolymer purified via dialysis.

Preferably, the manufacturing process claimed and described herein further comprises step (h) conducted after step (d):
dissolving the precipitate in water to obtain a solution containing the biopolymer chemically modified with the functional group selected from a carbon-carbon double bond, a carbon-carbon triple bond and a nitrogen-nitrogen triple bond, adding said solution to an organic solvent to obtain a suspension containing a precipitate of the biopolymer chemically modified with the functional group selected from a carbon-carbon double bond, a carbon-carbon triple bond and a nitrogen-nitrogen triple bond, and subjecting said suspension to filtration to obtain the precipitate and a filtrate. Preferably, step (h) is conducted at least twice. Preferably, step (h) is conducted at a temperature of between room temperature and 60° C.

At step (a) of the manufacturing process claimed and described herein, the biopolymer described herein is dissolved in an aqueous solution. Depending on the solubility of the biopolymer to be dissolved, step (a) may be conducted at a temperature of between room temperature and 60° C. For example, biopolymers such as polysaccharide salts and albumin can be dissolved in an aqueous solution at room temperature, and biopolymers such as gelatin can be dissolved in an aqueous solution at a temperature of between about 40° C. and about 60° C. Preferably, the concentration of the biopolymer in the aqueous solution is of between about 1 wt%/vol and about 20 wt %/vol, preferably of about 1 wt %/vol and about 10 wt %/vol.

The aqueous solution used at step (a) is preferably an aqueous acid solution, an aqueous base solution, or an aqueous buffer solution. Examples of suitable aqueous acid solutions include, but are not limited to, an acetic acid aqueous solution, preferably having a concentration of about 1-3 wt %/vol, a formic acid aqueous solution, preferably having a concentration of about 1-3 wt %/vol, and mixtures thereof. Examples of suitable aqueous base solutions include, but are not limited to, a sodium hydroxide aqueous solution, preferably having a concentration of about 5-15 wt %/vol, a lithium hydroxide aqueous solution, preferably having a concentration of about 5-15 wt %/vol, and mixtures thereof. Examples of suitable aqueous buffer solutions, include but are not limited to, a carbonate-bicarbonate buffer solution, preferably a 0.01-0.5 M carbonate-bicarbonate buffer solution, a phosphate buffer solution, a 2-(N-morpholino)ethanesulfonic acid (MES) buffer solution, a citric acid buffer solution, a borate buffer solution, and mixtures thereof. The aqueous solution is preferably free of organic solvents.

In one preferred embodiment, the biopolymer is a protein or a salt thereof. Examples of suitable proteins, include but are not limited to, gelatin, collagen, elastin, silk fibroin, albumin and mixtures thereof. Preferably, the protein is gelatin. If the biopolymer dissolved at step (a) is a protein or a salt thereof, then step (b) of the manufacturing process claimed and described herein preferably contains the following steps (b-1) to (b-4):
(b-1) adjusting the pH of the solution obtained at step (a) at a value of between about 2 and about 10;
(b-2) adding the chemical modifying agent to the solution obtained at step (b-1);
(b-3) stirring for about 0.5 to about 5 hours at a temperature of between room temperature and 60° C.; and
(b-4) stopping the reaction, preferably by adjusting the pH of the solution ata value of between about 6.5 and about 7.5.

Hence, a preferred embodiment according to the present invention relates to a process for manufacturing a protein chemically modified with a functional group selected from a carbon-carbon double bond, a carbon-carbon triple bond and a nitrogen-nitrogen triple bond, preferably of a protein chemically modified with a carbon-carbon double bond, said process comprising the following steps:
(a) dissolving a protein, a salt thereof or a mixture thereof in an aqueous solution, preferably an organic solvent free aqueous solution as defined herein;
(b-1) adjusting the pH of the solution obtained at step (a) at a value of between about 2 and about 10;
(b-2) adding the chemical modifying agent to the solution obtained at step (b-1);
(b-3) stirring for about 0.5 to about 5 hours at a temperature of between room temperature and 60 ° C.;
(b-4) stopping the reaction, preferably by adjusting the pH of the solution ata value of between about 6.5 and about 7.5;
(c) adding the solution obtained at step (c) to an organic solvent to obtain a suspension containing a precipitate of the protein chemically modified with the functional group selected from a carbon-carbon double bond, a carbon-carbon triple bond and a nitrogen-nitrogen triple bond;
(d) subjecting the suspension obtained at step (c) to filtration to obtain the precipitate and a filtrate;
(e) subjecting the filtrate to distillation to recover the organic solvent;
(f) drying the precipitate to obtain the protein chemically modified with the functional group selected from a carbon-carbon double bond, a carbon-carbon triple bond and a nitrogen-nitrogen triple bond; and
optionally step (g) subjecting the protein obtained at step (f) to a size reduction method to provide a particulate of said protein. Preferably, the manufacturing process further comprises step (h), which is preferably conducted at least twice.

It is within the common knowledge of the skilled person taking into account the structure of the protein to be chemically modified and of the chemical modifying agent to be used to adjust the pH of the solution at a suitable value of between about 2 and about 10 so that the hydroxyl and/or the amino groups and/or the carboxylic acid groups present on the protein react with the chemical modifying agent. For example, if gelatin is used as a biopolymer to be modified, the pH of the solution should be adjusted at step (b-1) at a value of between about 7 and about 10.

Preferably, the reaction is stopped at step (b-4) by adjusting the pH of the solution at a value of between about 6.5 and about 7.5. This can be achieved with an aqueous base solution as described herein, an aqueous acid solution as described herein or an aqueous buffer solution as described herein.

In a further preferred embodiment, the biopolymer is a polysaccharide or a salt thereof. Examples of suitable polysaccharides include, but are not limited to, alginic acid, gellan gum, pectin, polygalacturonic acid, carrageenan, hyaluronic acid, chitosan, chondroitin sulfuric acid, cellulose, carboxymethylcellulose, hydroxymethylcellulose, glycosaminoglycan, and mixtures thereof. Polysaccharides salts are preferably selected from sodium polysaccharide salts, potassium polysaccharide salts, ammonium polysaccharide salts, and mixtures thereof. In a more preferred embodiment, the biopolymer is a polysaccharide salt, preferably selected from sodium alginate, sodium hyaluronate, sodium gellan gum, sodium pectinate, sodium polygalacturonate, sodium carrageenan, sodium chondroitin sulphate, and mixtures thereof, more preferably selected from sodium alginate, sodium hyaluronate, and mixtures thereof.

If the biopolymer dissolved at step (a) is a polysaccharide or a salt thereof, then step (b) of the manufacturing process claimed and described herein preferably contains the following steps (b-5) and (b-6):
(b-5) adding the chemical modifying agent to the solution obtained at step (a); and
(b-6) stirring for at least three hours, preferably for at least 8 hours, more preferably for at least 12 hours, such as 24 hours, preferably at room temperature. Hence, a preferred embodiment according to the present invention relates to a process for manufacturing a polysaccharide chemically modified with a functional group selected from a carbon-carbon double bond, a carbon-carbon triple bond and a nitrogen-nitrogen triple bond, preferably of a polysaccharide chemically modified with a carbon-carbon double bond, said process comprising the following steps:
(a) dissolving a polysaccharide, a salt thereof or a mixture thereof in an aqueous solution, preferably an organic solvent free aqueous solution as defined herein;
(b-5) adding the chemical modifying agent to the solution obtained at step (a);
(b-6) stirring for at least three hours, preferably for at least 8 hours, more preferably for at least 12 hours, such as 24 hours, preferably at room temperature;
(c) adding the solution obtained at step (c) to an organic solvent to obtain a suspension containing a precipitate of the polysaccharide chemically modified with the functional group selected from a carbon-carbon double bond, a carbon-carbon triple bond and a nitrogen-nitrogen triple bond;
(d) subjecting the suspension obtained at step (c) to filtration to obtain the precipitate and a filtrate;
(e) subjecting the filtrate to distillation to recover the organic solvent;
(f) drying the precipitate to obtain the polysaccharide chemically modified with the functional group selected from a carbon-carbon double bond, a carbon-carbon triple bond and a nitrogen-nitrogen triple bond; and
optionally (g) subjecting the polysaccharide obtained at step (f) to a size reduction method to provide a particulate of said polysaccharide. Preferably, the manufacturing process further comprises step (h), which is preferably conducted at least twice.

In a preferred embodiment, the biopolymer dissolved at step (a) comprises at least two biopolymers, such as at least two different proteins, at least two different polysaccharides, ora mixture of a protein and a polysaccharide.

At step (b) of the manufacturing process claimed and described herein, the biopolymer is reacted with a chemical modifying agent so that a part of the free amine groups and/or the hydroxyl groups and/or carboxylic acid groups present on the biopolymer are substituted with a moiety containing a carbon-carbon double bond, a carbon-carbon triple bond and/or a nitrogen-nitrogen triple bond. The term “chemical modifying agent containing a carbon-carbon double bond, a carbon-carbon triple bond, and/or a nitrogen-nitrogen triple bond” as used herein refers to a molecule or compound comprising one moiety that may react with an amine and/or hydroxyl group and/or carboxylic acid group of the biopolymer and a second moiety containing a carbon-carbon double bond, a carbon-carbon triple bond and/or a nitrogen-nitrogen triple bond. The terms “chemical modifying agent containing a carbon-carbon double bond, a carbon-carbon triple bond and/or a nitrogen-nitrogen triple bond”, “chemical modifying agent” and “chemical modifier” are interchangeably used within the present patent application. “Moiety” as used herein, refers to a portion of a molecule or compound having a particular functional or structural feature. For example, a moiety may comprise a functional group or a reactive portion of a compound. Preferably, the chemical modifying agent is selected from (meth)acrylic anhydride, glycidyl (meth)acrylate, carbic anhydride, dibenzocyclooctyne-N-hydroxysuccinimidyl ester, dibenzocyclooctyne-amine, (1 R,8S,9s)-bicyclo[6.1.0]non-4-yn-9-ylmethanol, and mixtures thereof. More preferably, the chemical modifying agent is selected from (meth)acrylic anhydride, glycidyl (meth)acrylate, carbic anhydride, and mixtures thereof.

At step (c) of the manufacturing process claimed and described herein, the solution obtained at step (c) is added to an organic solvent to form a suspension containing a precipitate of the biopolymer chemically modified with a functional group selected from a carbon-carbon double bond, a carbon-carbon triple bond and a nitrogen-nitrogen triple bond. The organic solvent is preferably selected from an alcohol, such as a C₁-C₄ alcohol, an alcohol containing composition, such as a composition containing a C₁-C₄ alcohol, a ketone, an ester, an ether, chloroform and mixtures hereof. Examples of C₁-C₄ alcohols include methanol, ethanol, propanol, isopropanol, butanol, isobutanol and tert-butanol. Examples of suitable ketones include acetone and methyl ethyl ketone. Examples of suitable esters include ethyl acetate. The organic solvent is more preferably selected from an alcohol as defined herein, an alcohol containing composition as defined herein, and a ketone as defined herein, and even more preferably is selected from ethanol, propanol and isopropanol, methylated spirit (industrial methylated spirit, denaturated alcohol), acetone, methyl ethyl ketone, and mixtures thereof. In the most preferred embodiment, the organic solvent is selected from ethanol and denaturated alcohol. Step (c) is preferably conducted at room temperature. It is also preferred that the volume of the organic solvent is at least three times higher, more preferably at least eight times higher, even more preferably ten times higher than the volume of the solution containing the biopolymer chemically modified with a functional group selected from a carbon-carbon double bond, a carbon-carbon triple bond and a nitrogen-nitrogen triple bond.

The obtained suspension is subjected to filtration to separate the precipitate of the biopolymer chemically modified with the functional group selected from a carbon-carbon double bond, a carbon-carbon triple bond and a nitrogen-nitrogen triple bond and a filtrate. The obtained filtrate is further subjected to distillation to recycle the organic solvent used for precipitation of the biopolymer chemically modified with the functional group selected from a carbon-carbon double bond, a carbon-carbon triple bond and a nitrogen-nitrogen triple bond, which is reused in a further precipitation step.

At step (f) of the manufacturing process claimed and described herein, the precipitate of the biopolymer chemically modified with the functional group selected from a carbon-carbon double bond, a carbon-carbon triple bond and a nitrogen-nitrogen triple bond is dried to provide the biopolymer chemically modified with the functional group selected from a carbon-carbon double bond, a carbon-carbon triple bond and a nitrogen-nitrogen triple bond. The drying method used at step (f) is preferably selected from tray drying, freeze drying, conveyor drying, rotating drum drying, vacuum drying, and combinations thereof, and more preferably is freeze drying.

At step (g) of the manufacturing process claimed and described herein, the biopolymer obtained at step (f) is subjected to a size reduction method to provide a particulate of said biopolymer, which is particularly advantageous for storage (small storage spaces compared to the manufacturing processes using dialysis as purification method) and handling. Preferably, the size reduction method is selected from grinding, crushing, milling, and combinations thereof.

A second aspect according to the present invention is directed to a biopolymer chemically modified with a functional group selected from a carbon-carbon double bond, a carbon-carbon triple bond and a nitrogen-nitrogen triple bond, preferably a carbon-carbon double bond, preferably as a particulate, obtained by the process claimed and described herein. The particulate claimed and described herein can be stored in significantly smaller spaces as compared to the known cross-linkable biopolymer purified via dialysis. Further, the biopolymer claimed and described herein exhibits better mechanical strength properties than the known chemically modified biopolymer purified via dialysis.

A third aspect according to the present invention is directed to a hydrogel obtained by the process comprising the following steps:
i) dissolving the biopolymer claimed and described herein in a solution and optionally adding a radical initiator to said solution; and
ii) cross-linking the biopolymer modified with the functional group selected from a carbon-carbon double bond, a carbon-carbon triple bond and a nitrogen-nitrogen triple bond.

Preferably, the solution used at step i) is selected from phosphate buffer solution, RPMI 1640 medium (commercially available at Sigma Aldrich), Ham's F-10 nutrient mixture (commercially available at ThermoFischer), Ham's F-12 nutrient mixture (commercially available at ThermoFischer), Minimum Essential Medium (MEM) (commercially available at ThermoFischer), alpha Modified Eagle Medium (a-MEM) (commercially available at ThermoFischer), and Dulbeco Modified Eagle Medium (DMEM) (commercially available at ThermoFischer). Depending on the nature of the biopolymer chemically modified with the functional group selected from a carbon-carbon double bond, a carbon-carbon triple bond and a nitrogen-nitrogen triple bond, step i) may be conducted at a temperature of between room temperature and 60° C. A radical initiator, such as a thermal radical initiator (e.g.: ammonium persulfate) or a radical photoinitiator (e.g.: I rg acu re 2959 (2-hydroxy-4′-(2-hydroxyethoxy)-2-methylpropiophenone commercially available at Sigma Aldrich), lithium phenyl-2,4,6-trimethylbenzoylphosphinate), and/or a further biopolymer and/or cells such as primary cells (mesenchymal stem cells, smooth muscle cells, adipose cells) or cell lines (e.g. 3T3s cells, HeLa cells, induced pluripotent stem cells) may be added at step i) to the solution containing the biopolymer chemically modified with the functional group selected from a carbon-carbon double bond, a carbon-carbon triple bond and a nitrogen-nitrogen triple bond. Preferably, the solution obtained at step i) has a pH value of about 6.5 to about 7.5. At step ii) the biopolymer is cross-linked by heating the solution or irradiating the solution with irradiation with UV-Vis light or electron beam.

The manufacturing process of the hydrogel may further comprise steps iii) and iv):

iii) washing of the hydrogel obtained at step ii) with a solution;

iv) hydrating the hydrogel obtained at step iii).

Preferably, the solution used at step iii) is selected from phosphate buffer solution, RPMI 1640 medium, Ham's F-10 nutrient mixture, Ham's F-12 nutrient mixture, Minimum Essential Medium (MEM), alpha Modified Eagle Medium (a-MEM), and Dulbeco Modified Eagle Medium (DMEM).

The hydrogel may be obtained as a microparticulate.

To further illustrate the invention, the following examples are provided. These examples are provided with no intend to limit the scope of the invention.

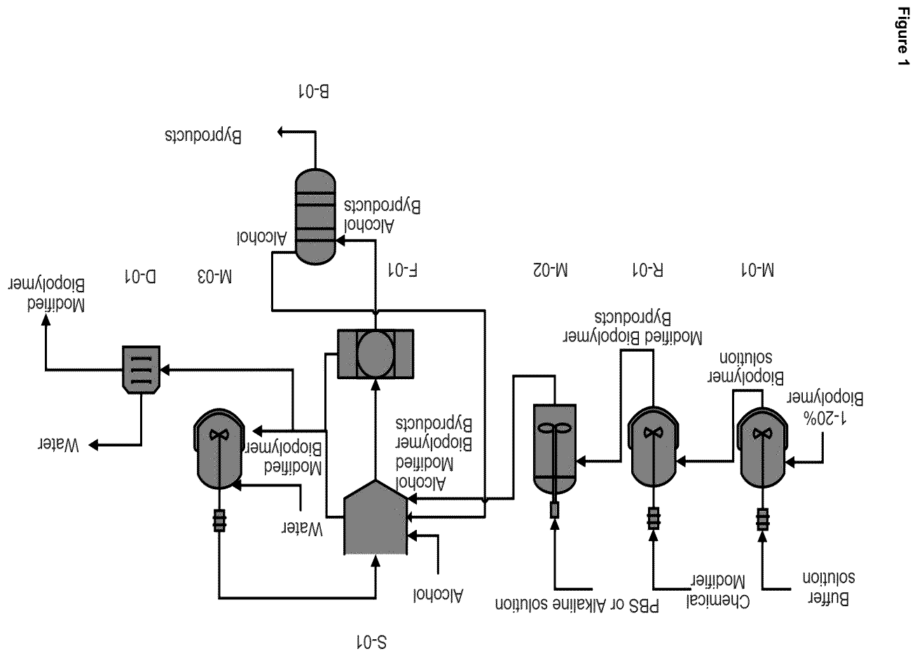

A particular process for producing a modified crosslinkable biopolymer (i.e. a biopolymer chemically modified with a functional group selected from a carbon-carbon double bond, a carbon-carbon triple bond and a nitrogen-nitrogen triple bond) is outlined as follows and summarized in FIG. 1:

A 1-20% wt/vol of the biopolymer is prepared by dissolving the biopolymer in a solvent or a buffer solution (M-01). A pH adjustment may be necessary to obtain optimal reaction conditions. After dissolution of the biopolymer, a chemical modifier (i.e. methacrylic anhydride, glycidyl methacrylate, carbic anhydride etc.) is added (R-01). After the reaction, the process can be halted by pH modification by the addition of acids or bases (M-02). It is noteworthy to mention that the M-01, R-01 and M-02 can occur on the same vessel, or for continuous process can be in series. The reaction liquid afterwards is precipitated readily by adding the solution in a large volume of solvent (S-01, with volume of precipitating solvent: 8-10x the amount of reaction liquid). The precipitate can be removed from the solvent via filtration (F-01) and dissolved to deionized water above 40° C. (M-03). The resulting solution is precipitated again, and this process was repeated 3x to ensure the complete removal of the unwanted by-products and unreacted components of the reaction. The filtrate which contains large amount of solvent can be recovered using distillation (B-01) for reuse in the precipitation step. The precipitated modified biopolymer was filtered to remove the remaining excess solvent, and then vacuum or freeze dried (D-01). The resulting product is a lump of solid material which can be dried and grinded; afterwards the modified biopolymer is stored at room temperature or freezer at −20° C. until use.

### Example 1. Manufacturing of a Gelatin Methacrylate (GeIMA) and Characterization

A 10% wt/vol gelatin was prepared by dissolving gelatin in 0.25 M carbonate-bicarbonate buffer at 60° C. and 700 rpm. Upon complete dissolution, the pH of the solution was adjusted to 9.0 using 5.0 N NaOH, as suggested by the study of Shirahama et al.

Synthesis. Sci Rep 6, 31036 (2016). While stirring, methacrylic anhydride was slowly added at a ratio of 0.2 mL/grams gelatin. The reaction was held in a light-free condition and minimized air uptake environment, where a narrow-necked reaction vessel was covered by aluminium foil. After 2 h of stirring at 60° C., the reaction mixture was cooled to room temperature and subsequently , the reaction was halted by neutralizing the solution into a pH of 7.4 by adding 5.0 N NaOH or 1 M NaHCO3. The reaction products were processed either via conventional dialysis method (method B), or precipitation method (method A) which will be discussed in the following sections.

### A.) Downstream Processing Of Gelatin Methacrylate (Geima) via Precipitation Method

The reaction liquid was precipitated readily by adding the solution dropwise in a large volume of denatured alcohol (volume of precipitating solvent: 10x the amount of reaction liquid). The precipitate was removed from the solvent via filtration and centrifugation, and was dissolved to deionized water at 60° C. and 700 rpm. The resulting solution was precipitated again, and this process was repeated 3x to ensure the complete removal of the unwanted by-products and unreacted components of the reaction. The precipitated GeIMA was pressed to remove the remaining excess solvent, and then freeze dried at −50° C. for 24h. The resulting product is a lump of solid material; afterwards the freeze-dried GeIMA was powdered using a coffee grinder, and was stored in a freezer at -20° C. until use. This is referred to as precipitated GeIMA (PR).

### B. Downstream Processing Of Gelatin Methacrylate (Geima) via The Commonly Used Dialysis Method

The effluent coming from the reactor was transferred to a dialysis bag with a molecular weight cutoff (MWCO) value of 12-14 kDa and suspended in a stirred vessel with deionized water at 40° C. for 7 days. The dialysis process was also kept in a light-free and minimized air uptake environment, with daily replacement of dialysis water. To obtain GeIMA in a water-free condition, the dialyzed GeIMA solution was snap-frozen by immersion in liquid nitrogen and freeze-dried at −50° C. to remove excess water for 7 days. The product obtained afterwards was a white, foamy GeIMA, and was stored in a freezer at −20° C. until use. The product is referred as dialyzed GeIMA (DI).

### C. Characterization of Synthesized GeIMA

### Morphological Analysis

Synthesized GeIMA were imaged using Environmental Scanning Electron Microscopy

(ESEM, FEI Quanta 650) under high vacuum mode. Dry samples were loaded unto aluminium stubs with carbon tabs to hold samples in place. Acceleration voltage used was 10 kV and several magnification modes were used for image capture, with at least 3 varying locations as a representative image of the synthesized GeIMA

### Degree of Substitution Assay

The TNBS method was used for the determination of degree of methacrylation in gelatin. Briefly, 15 mg of sample was dissolved in 2 mL of 4% wt/vol NaHCO₃ containing 0.01 M of TNBS and reacted at 40° C. and 125 rpm for 3 h. A 3 mL 6.0 N HCl was added into the solution and increased the temperature to T=80° C., leaving it for 1 h to react. The solution was then cooled to room temperature by immersing the reaction vial in a water bath, and then the solution was further diluted by adding 5 mL of distilled water. Absorbance was then measured at 345 nm using a 96-well plate reader (Infinite Pro, Tecan), and the degree of substitution (DS) from three independent, triplicate samples were calculated as follows:

$$DS = 100 \times ( 1 - \frac{{A}_{Gel MA} - {A}_{blank}}{{A}_{Gelatin} - {A}_{blank}} ) \qquad ( 1 )$$

### Molecular Weight Distribution via Gel Permeation Chromatography

To analyze the molecular weight distribution of GeIMA, gel permeation chromatography was used. A solution was prepared by dissolving gelatin methacrylate in tissue culture water at a concentration of 2.5 mg/mL. Aqueous GPC was performed using a Shimadzu UPLC system adapted with RID-10A differential refractive index detector. The eluent was DPBS, which used at 35° C. with a flow rate of 1 mL/min. The instrument was fitted with three PL aquagel-OH columns. PEG/PEO standards (EasiVial) were used to calibrate the columns. The number and weighted average molecular mass as well as the polydispersity of precipitated and dialyzed GeIMA was then calculated from the chromatogram data.

### Thermogravimetric Analysis

GeIMA DI and PR samples were analysed using a thermogravimetric analysis to determine solids content, which consists inorganic salts coming from the buffer solution and gelatin. A gram of each sample is loaded to a metallic pan, and afterwards subjected into heating in 99.5% oxygen atmosphere at a heating rate of 20° C. min-1 between ambient temperature and 1000° C. in a Mettler Thermal analyser. Continuous records of weight loss and temperature were analysed using the Mettler thermal analysis software, and the inorganic salts remaining at 1000° C. were determined from the % mass at the end point.

### Example 2. Production and Characterization of a GeIMA Hydrogel

The dissolving media was prepared beforehand by mixing DMEM (Dulbecco modified eagle medium purchased from Sigma Aldrich) with Irgacure 2959 (2-hydroxy-4′-(2-hydroxyethoxy)-2-methylpropiophenone purchased from Sigma Aldrich) at a concentration of 0.5% wt/vol, leaving the mixed solution overnight in an incubator. A 5 or 10% wt/vol of synthesized GeIMA was then dissolved in DMEM with photoinitiator by magnetic stirring at T=50° C. and 700 rpm. After complete dissolution, the solution was cooled at room temperature by immersion in a water bath for 10 min, and then adjusted its pH to ˜7.4 by using 1.0 M HCI. The cooled and pH adjusted solution was pipetted in a cylindrical Teflon mould (Ø=12 mm) at a volume of 250 μL and irradiated by a 15 W UV lamp with 365 nm wavelength for 5 min. Afterwards, the crosslinked GeIMA hydrogels were washed with PBS 3x to remove traces of the photoinitiator and then immersed in 3 mL DMEM containing antibiotic/antimycotic solution in an incubator at 37° C. and 5% CO2 for 24 hours to ensure full hydration of the sample.

### GeIMA Hydrogel Characterization

### Compressive Modulus Determination

For compressive modulus determination of swollen hydrogels, the samples were removed from the culture media, blotted the residual liquid by using a tissue, and the dimensions were measured using a caliper. The hydrogels were then loaded in a texture analyser (Stable Microsystems) with a 32-mm probe diameter and a 5 kg-load cell. A ramp displacement speed of 0.05 mm/s and 100% strain were used for the mechanical testing and the compressive modulus was computed on the linear region within 0-10% strain. From a batch of synthesized GeIMA, two independent experiments in triplicate were performed.

### Rheological Analysis

Rheological measurements for GeIMA hydrogels was done using Physica MCR 301 rheometer (Anton Paar, UK). A 25-mm cylindrical hydrated GeIMA hydrogel sample was cut and mounted on the rheometer with gap distance of 1 mm and a plate diameter of 25 mm. For strain sweeping test, storage (G′) and loss moduli (G″) were analysed at a constant frequency of 1 Hz and temperature of T=37° C. from 0.1-100%; time sweeping test were performed for 300 s at a constant frequency rate of 1 Hz, 0.5% strain, and T=37° C. Temperature sweep test range was from 25-50° C. at a heating rate of 2° C./min at a constant frequency rate of 1 Hz and 0.5% strain. From a batch of synthesized GeIMA, two independent experiments in triplicate were performed.

### Swelling Ratio Evaluation

Similar to the preparation of hydrogels from the compressive modulus determination, crosslinked GeIMA hydrogels were submerged in 3 mL DMEM in a 6-well plate at an incubator for 24 h. Afterwards, swollen hydrogels were harvested, removed excess water and weighed in a bijou. The hydrogels were then snap frozen by immersion in liquid nitrogen and subsequently freeze dried at −50° C. for 3 days to ensure complete removal of water. The weight of freeze dried hydrogel was recorded in triplicate, and the swelling ratio was computed as follows:

$$Swelling ratio = \frac{weight of hydrated GelMA hydrogel}{weight of freeze dried GelMA hydrogel} \qquad ( 2 )$$

### Cell Culture

An established lab cell line of NIH 3T3s in the lab was obtained and cultured using DMEM containing 10% Foetal Bovine Serum, 1% L-glutamine, and 1% antibiotic/antimycotic stock solution in a T75 flask. Cells were passaged every 3 days at 80-90% confluence, where the flasks are aspirated, washed with PBS, trypsinized for 5 mins, added culture media in a 1:5 ratio (one part of trypsin in 5 parts of culture media) to stop the reaction, centrifuged at 200g for 5 mins, and suspended in 1 mL volume of media. The split ratio was maintained at 1:4, and the passage number used in the experiments were 44-46.

### Cell Viability Assay

A 5-10% wt/vol of GeIMA was mixed in DMEM containing 0.5% wt/vol I rgacure 2959 and stored in an incubator for 5 h while stirring using a tube roller. After complete dissolution, the solution was filter sterilized in a cell culture hood using a 0.2 pm syringe filter and then stored overnight in an incubator. NIH 3T3 cells were then trypsinized and then suspended in GeIMA solution at a concentration of approximately 2×10⁶ cells/mL, and 10 μL of cell suspension was pipetted into a 24-well plate. The solution was then exposed to an Omnicure S2000 UV lamp with 320-500 nm wavelength for 15s at an intensity of 6.9 mW/cm 2 , and the crosslinked GeIMA hydrogels were maintained in DMEM supplemented with 10% Foetal Bovine Serum and 5% antibiotic/antimycotic stock solution for 4 days. Cell viability was quantified at day 1 and day 4 using calcein-AM/ethidium homodimer Live-Dead stain kit (Invitrogen) according to manufacturer's instructions.

### Statistical Analysis

Results from experiments were statistically analysed using One-way ANOVA at a 10 statistical significance criterion of p<0.05 To determine differences of the mean values,

Tukey's post-hoc test was performed. At least triplicate samples and 50 or more cells were analysed, and all error bars represent standard deviations. GraphPad Prism 7.0.3 was used to perform all statistical calculations.

### Results

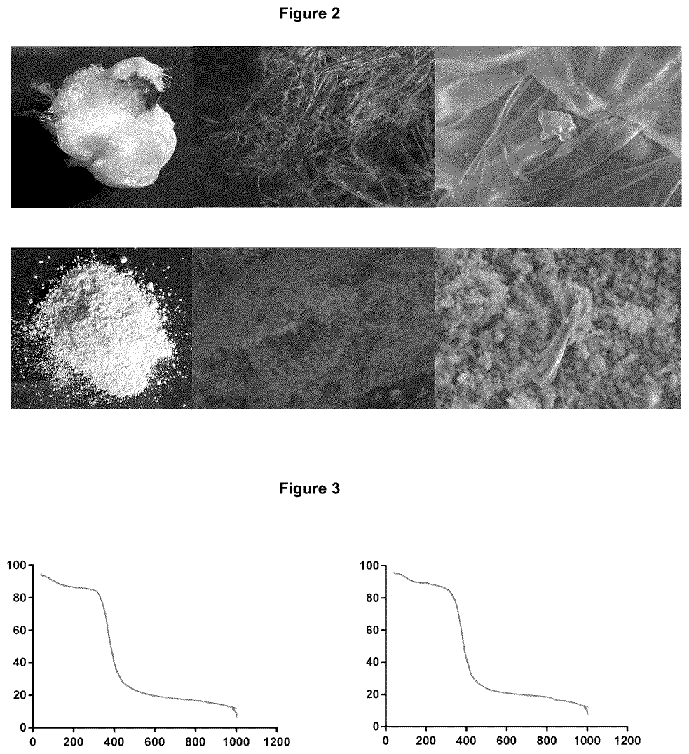

The morphology of the product of dialysis and precipitation methods clearly varies, from a sheet like structure to a powdered form. High density product can be obtained upon precipitation and therefore be stored easily in low-volume containers, whilst dialysed GeIMA require spacious storage requirements. After the reaction process, a conventional way of purifying GeIMA is using dialysis, where the reaction products are poured onto a membrane and suspended in water for several days at a constant temperature. The unwanted reaction products such as methacrylic acid and the unreacted methacrylic anhydride with the buffer salts used will start to diffuse out of the membrane upon suspension with water while GeIMA is retained in the membrane; constant replacement of water daily would purify the samples inside the membrane, with only GeIMA dissolved in water remaining. The water will be eventually removed by freeze drying the solution, leaving a foamy structure after processing (FIG. 2a). Dialysis usually last for 7 days, and freeze drying for 4-7 days (Nichol et al., Biomaterials 31 (2010) 5536-5544) depending on the water content of the post dialysis product, having the total purification time of about 11-14 days. On this process, large volume with low content of solids are processed, making the purification limited to a few grams of freeze-dried GeIMA.

In the precipitation method, separation of unwanted reaction products and GeIMA instantaneously happens due to phase separation. The reaction products are slowly poured to a large volume of alcohol, such as IMS (industrial methylated solvent) or ethanol: methacrylic acid and methacrylic anhydride diffuse to the alcohol because of their large solubility, while GeIMA, being insoluble to alcohol, precipitates. Buffer salts used in the reaction are likely to have been removed (via suspension in the alcohol) as suggested by the assessment of solids content using thermogravimetric analysis (FIG. 3), wherein there were no significant difference between the salt content of dialyzed (7.07±0.28%) and precipitated (7.18±0.59%) GeIMA (p=0.8328, n=2). The unwanted reaction products could co-precipitate with precipitated GeIMA, and so redissolution with water and subsequent precipitation can ensure significant removal of these by-products. Precipitated GeIMA can be removed from the alcohol suspension through filtration and centrifugation, leaving a compact solid mass where the solvent remaining is easily removed by vacuum or freeze-drying (FIG. 2b). Processing time for precipitation lasts only for a few hours, with solids drying occupying the majority of the processing time (12-24 h). Products produced are compact and powdered, requiring less volume for storage and increased ease of handling as compared to dialysis product of GeIMA purification with a significant fraction of a time reduced on overall processing. The process can also be easily scaled up, and the solvent (alcohol) can be recovered via distillation for re-use to increase overall economy. The degree of substitution of synthesized GeIMA were 97.77% and 93.28% for dialysis and precipitated processes respectively (n=3, four replicates); both degrees of substitution for DI and PR GeIMA show no significant difference (t-test, p=0.0623).

### Molecular Weight of GeIMA

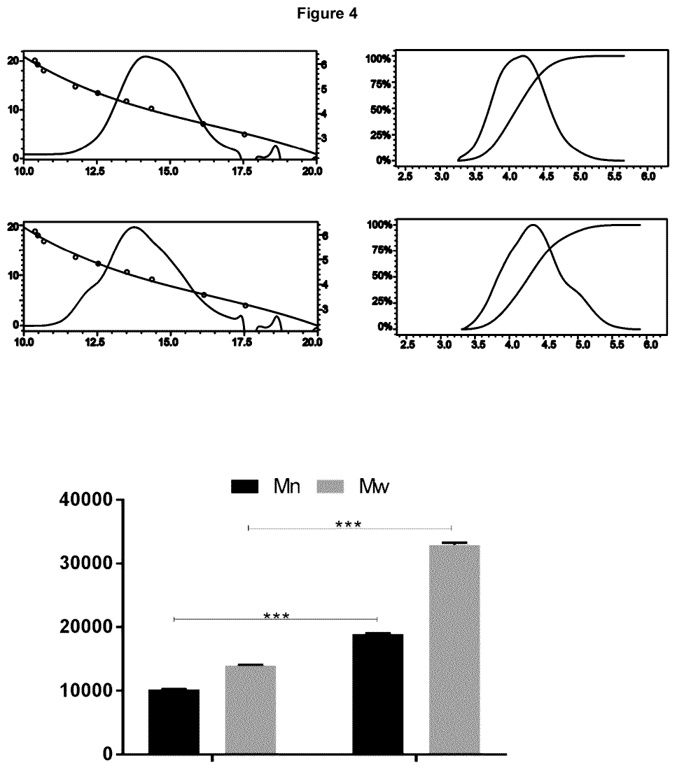

The manufacturer's published molecular weight for porcine gelatin with 175-225 bloom ranges from 40,000-50,000, and so considerable reduction of molecular weight is observed after processing in dialysis in contrast with precipitation method (see FIG. 4). Reduction of molecular weight is expected on the methacrylation of gelatin due to processing conditions, however considering also the prolonged suspension of GeIMA in aqueous solution at elevated temperature, hydrolysis of gelatin occurs during dialysis and so cleavage of peptide bonds reduce the molecular weight further (van den Bosch & Gielens, Int J Biol Macromol. 2003, 32(3-5): 129-38). The precipitation method removes the need for dialysis, and so molecular weight reduction is minimized, having the methacrylation the only main factor for molecular weight reduction. From the manufacturer's molecular weight specification (Sigma-Aldrich) of about 40 kDa on 175 bloom porcine gelatin, dialysis reduced GeIMA weighted mean molecular weight to 18.898±0.13 kDa (52.76% reduction) as compared to precipitated GeIMA weighted mean molecular weight of 32.93±0.35 (17.67% reduction). Molecular weight of GeIMA affects the overall mechanical strength of the hydrogel, which is evidenced in the subsequent discussion.

### Compressive Mechanical Strength and Swelling Ratio

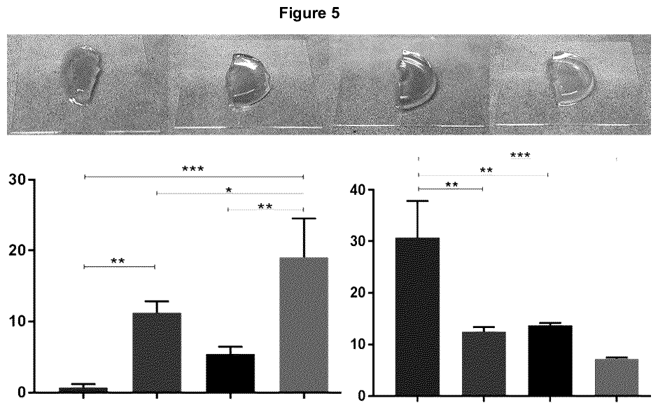

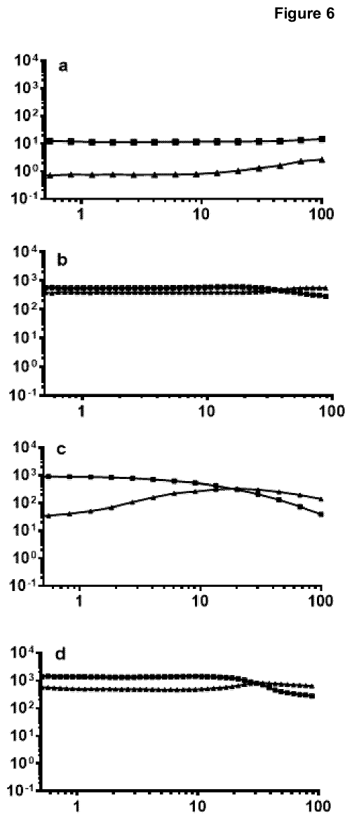

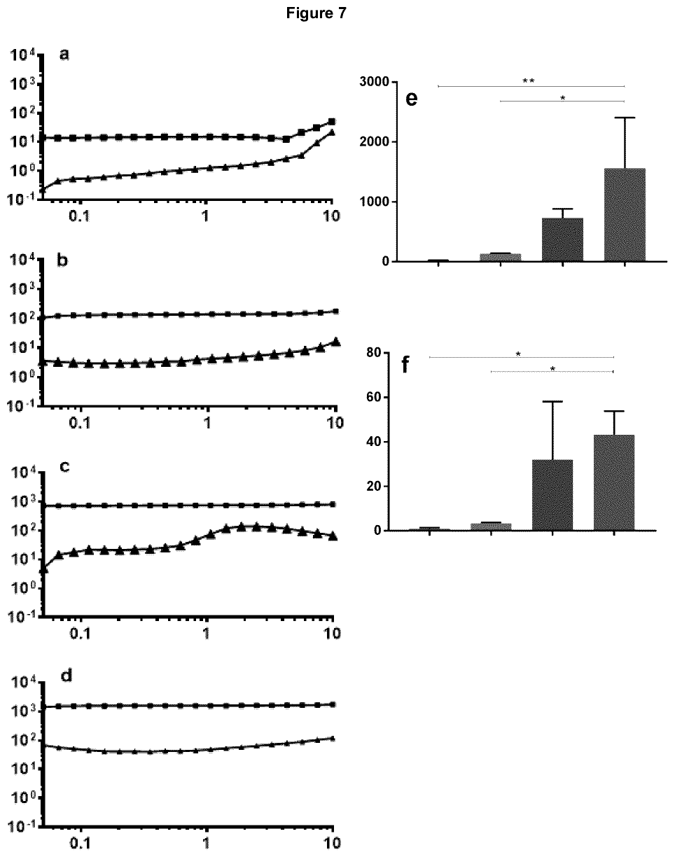

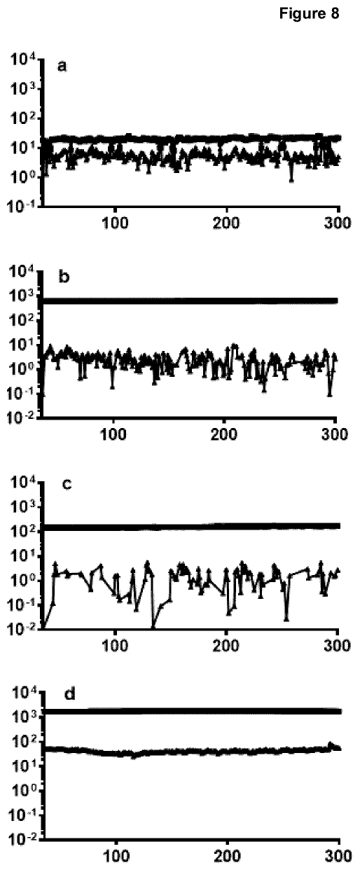

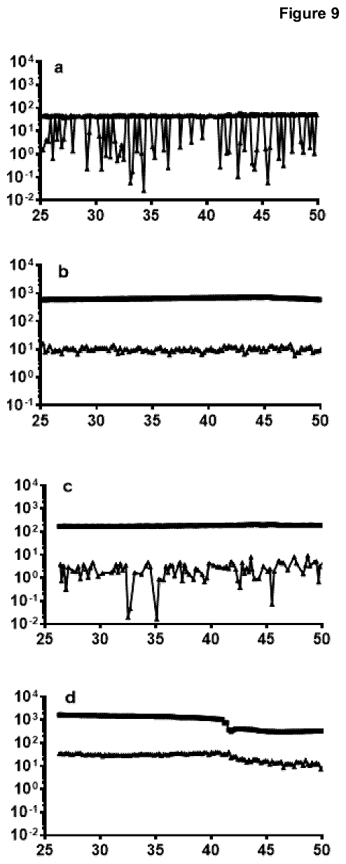

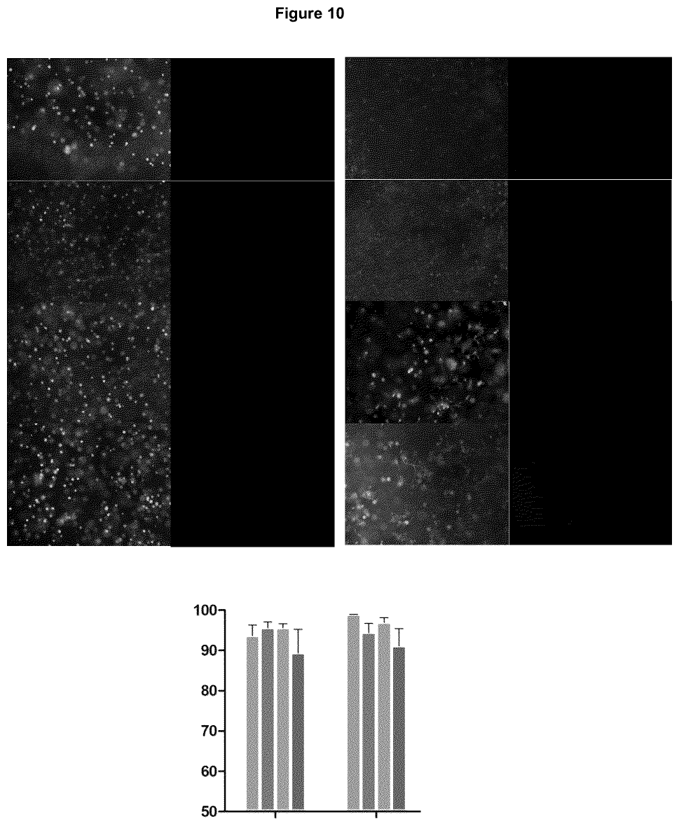

One of the inherent properties of polymers is that the mechanical strength is directly proportional to its molecular weight, where gelatin is actually graded in terms of bloom number. The higher the bloom number, the larger its molecular weight and so the more the stiffness of the gel is. Previous results show considerable reduction of molecular weight due to processes involving its transformation into GeIMA; effect of the molecular weight reduction is vividly seen in FIG. 5b. There is a sharp reduction of young's moduli between DI and PR GeIMA, which actually reflected the considerable molecular weight loss of dialysis as compared to precipitation. Measured values for 5% DI and PR were 0.7±0.5 and 11.23±1.59 kPa, and for 10% DI and PR were 5.43±1.02 and 19.03±5.5 kPa respectively; physical strength can clearly be seen on the photomicrographs in FIG. 5a. The swelling ratio, defined as the ratio of mass of water absorbed to the gel dry mass, is highest in 5% DI, while there were no significant differences in 5% PR, 10% DI and PR (FIG. 5c). With precipitated GeIMA, higher mechanical strength can therefore be obtained due to partial preservation of molecular weight of gelatin, and thus will be quite useful on tailoring range of young's moduli for specific 3D culture conditions.

### Rheological Analysis of GeIMA Hydrogels

Strain sweeps were done to evaluate the linear viscoelastic region (LVE) of the synthesized GeIMA, and all the samples behave linearly from 0.5% to 10% strain levels (FIG. 6). Affirming the LVE, the storage and loss modulus of GeIMA were determined via a frequency sweep (FIG. 7). Experimental values for storage moduli obtained were: 5% DI—14.73±7.96 Pa, 5% PR—135.04±5.95 Pa, 10% DI—734.44±146.85 Pa, 10% PR—1562.2±843.07 Pa; loss moduli: 5% DI—0.87±0.59 Pa, 5% PR—3.37±0.37 Pa, 10% DI—32.04±26.14 Pa, 10% PR—43.23±10.57 Pa. Storage and loss moduli is significantly higher at 10% PR as compared to 5% PR and DI, indicating a higher crosslinking density which is attributed to the molecular weight and polymer concentration of the sample. Time and temperature sweep (FIGS. 8 & 9) also shows homogeneity and stability of the viscoelastic properties of the GeIMA; the loss moduli fluctuations may be due to fluid transport gradients across the pores of the hydrogel albeit it is evident that it is in a pseudo-steady state trend. Stability at T=37° C. is necessary for culture conditions, ensuring homogenous initial conditions throughout the timeframe of cell culture.

### Biological Characterisation of Hydrogels

Cellular viability on all scaffolds after encapsulation are all higher than 85% after Day 1, indicating very low or no cytotoxicity upon contact with the scaffold. Focusing on the precipitated GeIMA, this supports the earlier result that the by-products produced from the methacrylation of gelatin, i.e. methacrylic acid and unreacted methacrylic anhydride, has been substantially removed considering that there are no significant differences between cell viabilities of dialyzed and precipitated GeIMA (FIG. 10e). Rounded morphology of NIH 3T3s is seen on Day 1 of encapsulation, whereas on Day 4 cellular protrusions are evident indicating cell attachment and proliferation. Qualitatively, more lengthy protrusions are seen in lower concentrations of GeIMA (5% DI and PR), which can be attributed to the mechanical strength of the scaffold as evidenced on several papers (Engler, Sen, Sweeney, & Discher, Cell 126, 677-689, 2006; Rehfeldt, Engler, Eckhardt, Ahmed, & Discher, Advanced Driug Delivery Review, 2007, 59, 1329-1339; Solon, Levental, Sengupta, Georges, & Janmey, Biophysical Journal, 2007, 93, 4453-4461) .

The synthesis of GeIMA has been successfully produced using dialysis and precipitation downstream processing techniques. Physical characterization has been made on the products through environmental scanning electron microscopy and thermogravimetric analysis, where a clear difference in morphology is seen—precipitated GeIMA in powder form and dialysis in foam; qualitatively the density is much higher in powdered form thereby allowing storage of bulk quantities in small space. The process has considerably reduced the amount of time for purification, with up to 86% as compared to the normal process. Thermogravimetric analysis showed that there has been no significant difference in salt content of the sample, as well as also confirming that the purity in terms of the presence of by-products within the product is comparable between the dialysed and precipitated GeIMA. The degree of methacrylation via TNBS assay is unaffected by both processes, however the molecular weight is much reduced in dialysis versus precipitated method likely due to hydrolysis of peptide bonds in the duration of the dialysis, which highly affected the overall mechanical strength of the photopolymerized hydrogel; Young's, storage, and loss moduli confirmed the effect of the reduction of molecular weight via compressive and rheological analysis of the hydrogels. Higher range of mechanical strength could be attained on precipitated GeIMA (up to 19 kPa, in contrast to dialysed GeIMA with the same concentration [10%], only up to 6 kPa), thereby allowing tuning of mechanical strength into larger range of values. Finally, cell viability was unaffected by the processes, with minimum viability of 85% on all of the encapsulated NIH 3T3s on both precipitated and dialysed GeIMA, further affirming the removal of toxic by-products of the methacrylation of gelatin in precipitation process. At day 4, the cells in 5% GeIMA (DI and PR) have more pronounced cellular protrusions, indicating motility and phenotype changes as compared to 10% GeIMA. This is likely due to the porosity and the mechanical strength of the hydrogels (Engler et al., 2006; Rehfeldt et al., 2007; Solon et al., 2007), where less concentration of GeIMA provides larger pores and so does the ease of cellular movement. Overall, precipitated GeIMA can be used as a platform for 3D cell culture work, with a higher range of mechanical strength values as compared to the dialysed downstream processing technique.

### Example 3. Manufacturing of an Alginic Acid Methacrylate and Characterization

1% wt/vol sodium alginate is dissolved in a carbonate-bicarbonate buffer at pH 9 overnight. After dissolution, 20 molar excess of methacrylic anhydride was added dropwise into the alginate solution. The solution was left stirring for 72 hrs and then precipitated into denatured ethanol 10x the volume of the reaction. The precipitate was then collected, washed again in ethanol, and then dissolved again in water. The process of precipitation-washing-dissolution was repeated 3x, and the final precipitated alginate methacrylate was freeze dried overnight. The dried alginate was grinded into powder, and using NMR, the degree of methacrylation is 28.82% substituted.

### Example 4. Manufacturing of a Hyaluronic Acid Methacrylate and Characterization

1% wt/vol sodium hyaluronate is dissolved in a carbonate-bicarbonate buffer at pH 9 overnight. After dissolution, 10 molar excess of methacrylic anhydride was added dropwise into the sodium hyaluronate solution. The solution was left stirring for 12 hrs and then precipitated into denatured ethanol 10x the volume of the reaction. The precipitate was then collected, washed again in ethanol, and then dissolved again in water. The process of precipitation-washing-dissolution was repeated 3x, and the final precipitated hyaluronic acid methacrylate (HAMA) was freeze dried overnight. The dried HAMA was grinded into powder, and using NMR, the degree of methacrylation is 67.23% substituted.

The present invention may be further summarized by reference to the following clauses #1 - #5:
#1. A process to mass produce modified biopolymers from a raw material via precipitation and drying, the steps comprising of:
(1) dissolving the biopolymers in a buffer solution;
(2) adding a chemical modifier;
(3) purifying by adding the modified biopolymer solution in a precipitating solution;
(4) recovering the precipitating solution via distillation;
(5) drying to obtain the product,
   wherein the raw material used is selected from the group comprising of gelatin, alginate, hyaluronic acid, chitosan, chondroitin sulphate, collagen, elastin, cellulose, and silk fibroin;
   wherein the product produced is modified biopolymers in high-density powdered form and can be crosslinked to form hydrogels, nanofibers and other biomedical materials.
#2. The buffer solution of claim 1 is selected from the group comprising of: 0.01-0.5 M Carbonate-Bicarbonate buffer, phosphate buffered solution, organic solvents for polysaccharides, or a mixture thereof.
#3. The chemical modifier of claim 1 is selected from the group comprising of methacrylic anhydride, glycidyl methacrylate, and carbic anhydride
#4. The precipitating solution used in claim 1 is selected from the group comprising of ethanol, acetone, methylated spirits, dimethyl sulfoxide, propanol, and chloroform.
#5. The drying method in claim 1 is selected from the group comprising of tray drying, freeze drying, conveyor drying, rotating drum drying, or a combination thereof.

1. A process for manufacturing a biopolymer chemically modified with a functional group selected from a carbon-carbon double bond, a carbon-carbon triple bond and a nitrogen-nitrogen triple bond, said process comprising the following steps:
(a) dissolving a biopolymer in an aqueous solution, wherein said biopolymer is selected from a protein, a polysaccharide, a salt thereof, and a mixture thereof;
(b) reacting the biopolymer with a chemical modifying agent containing a carbon-carbon double bond, a carbon-carbon triple bond, and/or a nitrogen-nitrogen triple bond to obtain a solution containing a biopolymer chemically modified with a functional group selected from a carbon-carbon double bond, a carbon-carbon triple bond and a nitrogen-nitrogen triple bond;
(c) adding the solution obtained at step (c) to an organic solvent to obtain a suspension containing a precipitate of the biopolymer chemically modified with the functional group selected from a carbon-carbon double bond, a carbon-carbon triple bond and a nitrogen-nitrogen triple bond;
(d) subjecting the suspension obtained at step (c) to filtration to obtain the precipitate and a filtrate;
(e) subjecting the filtrate to distillation to recover the organic solvent; and
(f) drying the precipitate to obtain the biopolymer chemically modified with the functional group selected from a carbon-carbon double bond, a carbon-carbon triple bond and a nitrogen-nitrogen triple bond.

2. The process according to claim 1, wherein the biopolymer chemically modified with the functional group selected from a carbon-carbon double bond, a carbon-carbon triple bond and a nitrogen-nitrogen triple bond is a particulate, and the process further comprises step (g) conducted after step (f):
(g) subjecting the biopolymer obtained at step (f) to a size reduction method to provide a particulate of said biopolymer.

3. The process according to claim 1, further comprising step (h) conducted after step (d):
dissolving the precipitate in water to obtain a solution containing the biopolymer chemically modified with the functional group selected from a carbon-carbon double bond, a carbon-carbon triple bond and a nitrogen-nitrogen triple bond, adding said solution to an organic solvent to obtain a suspension containing a precipitate of the biopolymer chemically modified with the functional group selected from a carbon-carbon double bond, a carbon-carbon triple bond and a nitrogen-nitrogen triple bond, and subjecting said suspension to filtration to obtain the precipitate and a filtrate.

4. The process according to claim 1, wherein the aqueous solution is selected from an aqueous acid solution, an aqueous base solution and an aqueous buffer solution.

5. The process according to claim 1, wherein the biopolymer comprises at least two biopolymers.

6. The process according to claim 1, wherein the protein is selected from gelatin, collagen, elastin, silk fibroin, albumin and mixtures thereof.

7. The process according to claim 6, wherein step (b) comprises the following steps:
(b-1) adjusting the pH of the solution at a value of between about 2 and about 10;
(b-2) adding the chemical modifying agent to the solution obtained at step (b-1);
(b-3) stirring for about 0.5 to about 5 hours at a temperature of between room temperature and 60° C.; and
(b-4) stopping the reaction, preferably by adjusting the pH of the solution at a value of between about 6.5 and about 7.5.

8. The process according to any claim 1, wherein the polysaccharide is selected from alginic acid, gellan gum, pectin, polygalacturonic acid, carrageenan, hyaluronic acid, chitosan, chondroitin sulphuric acid, cellulose, carboxymethylcellulose, hydroxymethylcellulose, glycosaminoglycan, and mixtures thereof.

9. The process according to claim 8, wherein the biopolymer is a polysaccharide salt.

10. The process according to claim 8, wherein step (b) comprises the following steps:
(b-5) adding the chemical modifying agent to the solution obtained at step (a); and
(b-6) stirring, for at least three hours.

11. The process according to claim 1, wherein the chemical modifying agent is selected from (meth)acrylic anhydride, glycidyl (meth)acrylate, carbic anhydride, and mixtures thereof

12. The process according to claim 1, wherein the organic solvent is selected from an alcohol, an alcohol containing composition, a ketone, an ester, an ether, chloroform and mixtures thereof.

13. The process according to claim 1, wherein the drying is selected from tray drying, freeze drying, conveyor drying, rotating drum drying, vacuum drying, and combinations thereof, and/or the size reduction method is selected from grinding, crushing, milling, and combinations thereof

14. A biopolymer chemically modified with a functional group selected from a carbon-carbon double bond, a carbon-carbon triple bond and a nitrogen-nitrogen triple bond obtained by the process according to claim 1.

15. A hydrogel obtained by the process comprising the following steps:
i) dissolving the biopolymer chemically modified with the functional group selected from a carbon-carbon double bond, a carbon-carbon triple bond and a nitrogen-nitrogen triple bond according to claim 14 in a solution and optionally adding a radical initiator to said solution; and
ii) cross-linking the biopolymer.
